(19) United States
(12) Patent Application Publication
(10) Pub. No.: US 2025/0022257 A1
(43) Pub. Date: Jan. 16, 2025

(54) DEVICE AND METHOD FOR GENERATING LANE POLYLINE USING NEURAL NETWORK MODEL

(71) Applicant: 42DOT INC., Seoul (KR)

(72) Inventors: Seong Gyun JEONG, Yongin (KR); Hee Yeon KWON, Seoul (KR); Seok Woo JUNG, Seoul (KR)

(21) Appl. No.: 18/687,024

(22) PCT Filed: Sep. 7, 2022
(86) PCT No.: PCT/KR2022/013480

§ 371 Date: Oct. 1, 2024

(30) Foreign Application Priority Data
Sep. 7, 2021 (KR) 10-2021-0119292
Jun. 24, 2022 (KR) 10-2022-0077475
Jun. 24, 2022 (KR) 10-2022-0077498

(51) Int. Cl. G06V 10/774; B60W 40/06; G06V 10/762; G06V 10/776; G06V 10/82; G06V 20/56

(52) U.S. Cl. CPC G06V 10/774; G06V 10/762; G06V 10/776; G06V 10/82; G06V 20/588; B60W 40/06; B60W 2420/403

(57) ABSTRACT

The present disclosure relates to a method and device for generating a lane polyline by using a neural network model.

The method according to an embodiment of the present disclosure may include generating a bird's-eye-view feature based on a base image obtained from at least one sensor mounted on a vehicle, and training a neural network model by using the bird's-eye-view feature as input data for the neural network model and using a lane polyline for a certain road as output data. In the present disclosure, a lane polyline obtained from the above-described neural network model may be used for controlling the vehicle without performing a separate process on the lane polyline.

### TECHNICAL FIELD

The present disclosure relates to a device and method for generating a lane polyline by using a neural network model.

### BACKGROUND ART

Along with the merging of information communication technology and the vehicle industry, smartization of vehicles is rapidly progressing. The smartization of vehicles enables the vehicles to evolve from simple mechanical devices to smart cars, and in particular, autonomous driving is attracting attention as a core technology of smart cars. Autonomous driving is a technology that allows a vehicle to reach its destination on its own without a driver manipulating the steering wheel, accelerator pedal, or brake.

Recently, with the advancement of technology, safe driving assistance systems such as lane departure warning systems or lane keeping, automatic vehicle control systems, and the like have been developed, and commercialization thereof is rapidly progressing. In particular, detection of driving lanes is one of the core technologies for solving major problems in autonomous vehicles, and many studies are being actively conducted with international interest.

Because detection of driving lanes has a significant impact on safe driving, various sensors are used to accurately detect a driving lane to estimate and determine the location of the lane. For example, various sensors such as image sensors, radar or lidar sensors are used individually or in a combination to implement an autonomous vehicle control system for lane detection or object recognition in front of a vehicle.

The above-mentioned background art is technical information possessed by the inventor for the derivation of the present disclosure or acquired during the derivation of the present disclosure, and cannot necessarily be said to be a known technique disclosed to the general public prior to the filing of the present disclosure.

### Disclosure

### Technical Problem

The present disclosure provides a device and method for generating a lane polyline by using a neural network model. Technical objectives of the present disclosure are not limited to the foregoing, and other unmentioned objectives or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

### Technical Solution

A first aspect of the present disclosure may provide a method of generating a lane polyline by using a neural network model, the method including: obtaining a base image of a certain road from at least one sensor mounted on a vehicle; extracting a multi-scale image feature by using the base image; generating a bird's-eye-view (BEV) feature by performing view transformation on the extracted multi-scale image feature; and training a neural network model by using the BEV feature as input data for the neural network model and using a lane polyline for the certain road as output data.

In addition, a setting of the seed probability loss may include setting the seed probability loss including a first formula and a second formula by applying the first formula to foreground pixels corresponding to the foreground among a plurality of pixels and applying the second formula to background pixels corresponding to the background.

In addition, the method may further include: calculating a probability that each of the foreground pixels corresponds to a certain cluster among a plurality of clusters respectively corresponding to a plurality of lanes included in the certain road; and setting the first formula based on pixel values of the foreground pixels and the calculated probability.

In addition, the method may further include setting the second formula based on the pixel values of the background pixels.

In addition, the setting of the first formula may include setting the first formula by further applying a scaling factor to correct the imbalance between the pixel values of the foreground pixels and the pixel values of the background pixels.

In addition, the training of the neural network model may include extracting foreground pixels corresponding to the foreground from a plurality of pixels included in the BEV feature; setting an order loss using an order of each of the foreground pixels for a lane included in the certain road; and training the neural network model by using the order loss.

In addition, the setting of the order loss may include: identifying a cluster including each of the foreground pixels; determining order values of foreground pixels for a lane corresponding to the identified cluster; and setting the order loss using the order value for each of the foreground pixels.

In addition, the determining of the order values may include determining the order values of the foreground pixels such that, as the distance between the starting point of the lane and the foreground pixel decreases, the order value is closer to a first value, and as the distance between the ending point of the lane and the foreground pixel decreases, the order value is closer to a second value.

In addition, the method may further includes inputting the BEV feature as input data for the neural network model that is trained by the method of the first aspect; and generating a lane polyline for the certain road as output data of the neural network model.

In addition, the method may further include, based on the lane polyline for the certain road, generating a control signal for controlling the vehicle traveling on the certain road.

A second aspect of the present disclosure may provide a device for generating a lane polyline by using a neural network model, the device including: a memory storing at least one program; and a processor configured to execute the at least one program to operate a neural network, wherein the processor is further configured to obtain a base image of a certain road from a camera mounted on a vehicle, extract a plurality of image features by using the base image, generate a BEV feature by performing view transformation on the extracted plurality of image features, and train a neural network model by using the BEV feature as input data for the neural network model and using a lane polyline for the certain road as output data.

A third aspect of the present disclosure may provide a method of generating a lane polyline by using a neural network model, the method including: generating a BEV feature based on a base image of a certain road from at least one sensor mounted on a vehicle; and training a neural network model by using the BEV feature as input data for the neural network model and using a lane polyline for the certain road as output data, wherein the training of the neural network model comprises: setting a seed probability loss based on whether each of a plurality of pixels included in the BEV feature corresponds to a category of foreground or background; and training the neural network model by using the seed probability loss.

In addition, the setting of the seed probability loss may include setting the seed probability loss including a first formula and a second formula by applying the first formula to foreground pixels corresponding to the foreground among a plurality of pixels and applying the second formula to background pixels corresponding to the background.

In addition, the method may further include: calculating a probability that each of the foreground pixels corresponds to a certain cluster among a plurality of clusters respectively corresponding to a plurality of lanes included in the certain road; and setting the first formula based on pixel values of the foreground pixels and the calculated probability.

In addition, the method may further include setting the second formula based on the pixel values of the background pixels.

In addition, the setting of the first formula may include setting the first formula by further applying a scaling factor to correct the imbalance between the pixel values of the foreground pixels and the pixel values of the background pixels.

In addition, the training of the neural network model may include extracting foreground pixels corresponding to the foreground from a plurality of pixels included in the BEV feature; setting an order loss using an order of each of the foreground pixels for a lane included in the certain road; and training the neural network model by using the order loss.

In addition, the setting of the order loss may include: identifying a cluster including each of the foreground pixels; determining order values of foreground pixels for a lane corresponding to the identified cluster; and setting the order loss using the order value for each of the foreground pixels.

In addition, the determining of the order values may include determining the order values of the foreground pixels such that, as the distance between the starting point of the lane and the foreground pixel decreases, the order value is closer to a first value, and as the distance between the ending point of the lane and the foreground pixel decreases, the order value is closer to a second value.

In addition, the method may further includes inputting the BEV feature as input data for the neural network model that is trained by the method of the third aspect; and generating a lane polyline for the certain road as output data of the neural network model.

In addition, the method may further include, based on the lane polyline for the certain road, generating a control signal for controlling the vehicle traveling on the certain road.

A fourth aspect of the present disclosure may provide a device for generating a lane polyline by using a neural network model, the device including: a memory storing at least one program; and a processor configured to execute the at least one program to operate a neural network, wherein the processor is further configured to generate a BEV feature based on a base image of a certain road from at least one sensor mounted on a vehicle, and train a neural network model by using the BEV feature as input data for the neural network model and using a lane polyline for the certain road as output data, and the processor is further configured to set a seed probability loss based on whether each of a plurality of pixels included in the BEV feature corresponds to a category of foreground or background, and train the neural network model by using the seed probability loss.

A fifth aspect of the present disclosure may provide a computer-readable recording medium having recorded thereon a program for causing a computer to execute the method of the first aspect or the third aspect.

In addition, other methods and systems for implementing the present disclosure, and a computer-readable recording medium having recorded thereon a computer program for executing the methods may be further provided.

Other aspects, features, advantages other than those described above will become apparent from the following drawings, claims, and detailed description of the present disclosure.

### Advantageous Effects

According to an embodiment of the present disclosure, in the present disclosure, a lane polyline for a certain road may be obtained with high accuracy from a bird's-eye-view feature through end-to-end learning of a neural network model.

In addition, in the present disclosure, a lane polyline obtained from the neural network model may be used for controlling a vehicle without performing a separate process on the lane polyline.

### DESCRIPTION OF DRAWINGS

FIGS. 1 to 3 are diagrams for describing an autonomous driving method according to an embodiment.

FIG. 4 is an exemplary diagram for describing a method of performing image encoding and view transformation, according to an embodiment.

FIG. 5 is an exemplary diagram for describing a method of generating a bird's-eye-view feature, according to an embodiment.

FIG. 6 is an exemplary diagram for describing a method of operating a neural network model, according to an embodiment.

FIGS. 7A and 7B are exemplary diagrams for describing a seed probability loss according to an embodiment.

FIGS. 8A to 8C are exemplary diagrams for describing an embedding offset loss.

FIG. 9 is an exemplary diagram for describing an order loss according to an embodiment.

FIG. 10 is a flowchart for describing a method of generating a lane polyline by using a neural network model, according to an embodiment.

FIG. 11 is a block diagram of a lane polyline generating device according to an embodiment.

### BEST MODE

The present disclosure relates to a method and device for generating a lane polyline by using a neural network model. The method according to an embodiment of the present disclosure may include generating a bird's-eye-view feature based on a base image obtained from at least one sensor mounted on a vehicle, and training a neural network model by using the bird's-eye-view feature as input data for the neural network model and using a lane polyline for a certain road as output data. In the present disclosure, a lane polyline obtained from the above-described neural network model may be used for controlling the vehicle without performing a separate process on the lane polyline.

### MODE FOR INVENTION

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. Singular forms are intended to include plural forms as well, unless the context clearly indicates otherwise. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Some embodiments of the present disclosure may be represented by functional block components and various processing operations. Some or all of the functional blocks may be implemented by any number of hardware and/or software elements that perform particular functions. For example, the functional blocks of the disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, the term ‘vehicle’ may refer to all types of transportation instruments with engines that are used to move passengers or goods, such as cars, buses, motorcycles, kick scooters, or trucks.

Hereinafter, the present disclosure will be described in detail with reference to the accompanying drawings.

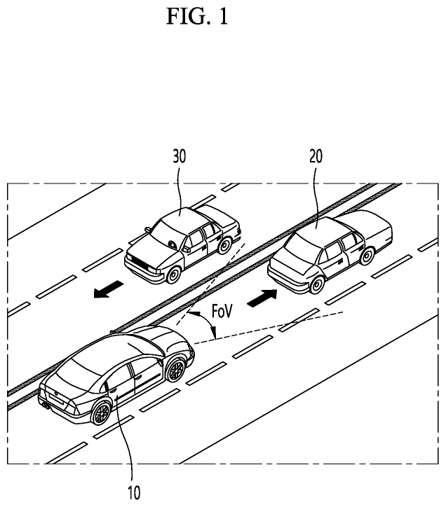

FIGS. 1 to 3 are diagrams for describing an autonomous driving method according to an embodiment.

Referring to FIG. 1, an autonomous driving device according to an embodiment of the present disclosure may be mounted on a vehicle to implement an autonomous vehicle 10. The autonomous driving device mounted on the autonomous vehicle 10 may include various sensors configured to collect situational information around the autonomous vehicle 10. For example, the autonomous driving device may detect a movement of a preceding vehicle 20 traveling in front of the autonomous vehicle 10, through an image sensor and/or an event sensor mounted on the front side of the autonomous vehicle 10. The autonomous driving device may further include sensors configured to detect, in addition to the preceding vehicle 20 traveling in front of the autonomous vehicle 10, another traveling vehicle 30 traveling in an adjacent lane, and pedestrians around the autonomous vehicle 10.

At least one of the sensors configured to collect the situational information around the autonomous vehicle may have a certain field of view (FoV) as illustrated in FIG. 1. For example, in a case in which a sensor mounted on the front side of the autonomous vehicle 10 has a FoV as illustrated in FIG. 1, information detected from the center of the sensor may have a relatively high importance. This may be because most of information corresponding to the movement of the preceding vehicle 20 is included in the information detected from the center of the sensor.

The autonomous driving device may control the movement of the autonomous vehicle 10 by processing information collected by the sensors of the autonomous vehicle 10 in real time. In addition, the autonomous driving device may store at least some of information collected by the sensors in a memory device.

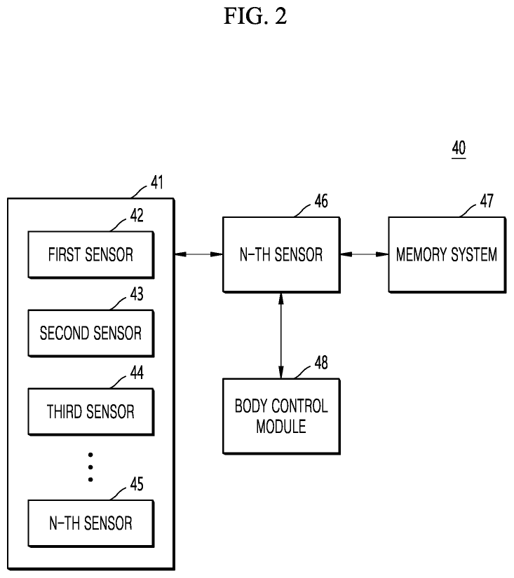

Referring to FIG. 2, an autonomous driving device 40 may include a sensor unit 41, a processor 46, a memory system 47, a body control module 48, and the like. The sensor unit 41 may include a plurality of sensors 42 to 45, and the plurality of sensors 42 to 45 may include an image sensor, an event sensor, an illuminance sensor, a global positioning system (GPS) device, an acceleration sensor, and the like.

Data collected by the sensors 42 to 45 may be delivered to the processor 46. The processor 46 may store the data collected by the sensors 42 to 45 in the memory system 47. In addition, the processor 46 may determine the movement of the vehicle by controlling the body control module 48 based on the data collected by the sensors 42 to 45. The memory system 47 may include two or more memory devices and a system controller configured to control the memory devices. Each of the memory devices may be provided as a single semiconductor chip.

In addition to the system controller of the memory system 47, each of the memory devices included in the memory system 47 may include a memory controller, which may include an artificial intelligence (AI) computation circuit such as a neural network. The memory controller may generate computational data by applying certain weights to data received from the sensors 42 to 45 or the processor 46, and store the computational data in a memory chip.

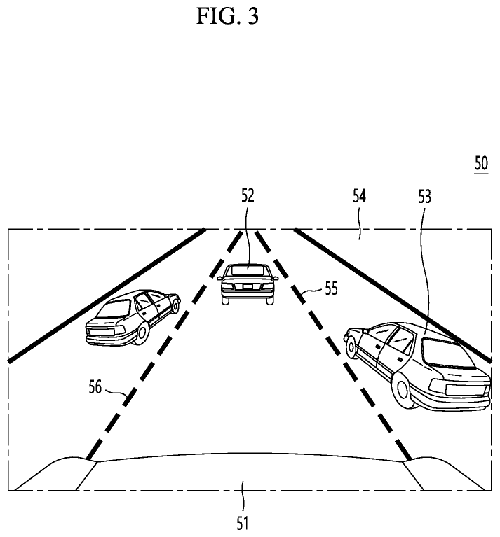

FIG. 3 is a diagram illustrating an example of image data obtained by a sensor of an autonomous vehicle on which an autonomous driving device is mounted. Referring to FIG. 3, image data 50 may be data obtained by a sensor mounted on the front side of the autonomous vehicle. Thus, the image data 50 may include a front area 51 of the autonomous vehicle, a preceding vehicle 52 traveling in the same lane as the autonomous vehicle, a traveling vehicle 53 around the autonomous vehicle, a background 54, lanes 55 and 56, and the like.

In the image data 50 according to the embodiment illustrated in FIG. 3, data regarding a region including the front area 51 of the autonomous vehicle and the background 54 may be unlikely to affect the driving of the autonomous vehicle. In other words, the front area 51 of the autonomous vehicle and the background 54 may be regarded as data having a relatively low importance.

On the other hand, the distance to the preceding vehicle 52 and a movement of the traveling vehicle 53 to change lanes or the like may be significantly important factors in terms of safe driving of the autonomous vehicle. Accordingly, data regarding a region including the preceding vehicle 52 and the traveling vehicle 53 in the image data 50 may have a relatively high importance in terms of the driving of the autonomous vehicle.

A memory device included in the autonomous driving device may apply different weights to different regions of the image data 50 received from a sensor, and then store the image data 50. For example, the memory device may apply a high weight to the data regarding the region including the preceding vehicle 52 and the traveling vehicle 53, and apply a low weight to the data regarding the region including the front area 51 of the autonomous vehicle and the background 54.

In addition, the autonomous driving device may detect the lanes 55 and 56 included in the road on which the vehicle is currently traveling. For example, the autonomous driving device may detect lane pixels that are highly likely to correspond to a lane in the image data 50 through image processing, and determine a situation of arrangement of lanes in front of the vehicle by fitting the detected lane pixels to a particular lane model.

In an embodiment, the autonomous driving device may detect lane pixels in the image data 50 by using a neural network model. The neural network model is a model trained to detect lane pixels corresponding to a lane in the image data 50. The image data 50 may be input into the neural network model. In addition, the neural network model may output probability information indicating a probability that each image pixel included in the image data 50 corresponds to the lanes 55 and 56. The autonomous driving device may determine lane pixels based on the probability information for each pixel. For example, the autonomous driving device may determine, as lane pixels, image pixels of the image data 50 whose probabilities determined by the neural network model are greater than a threshold value.

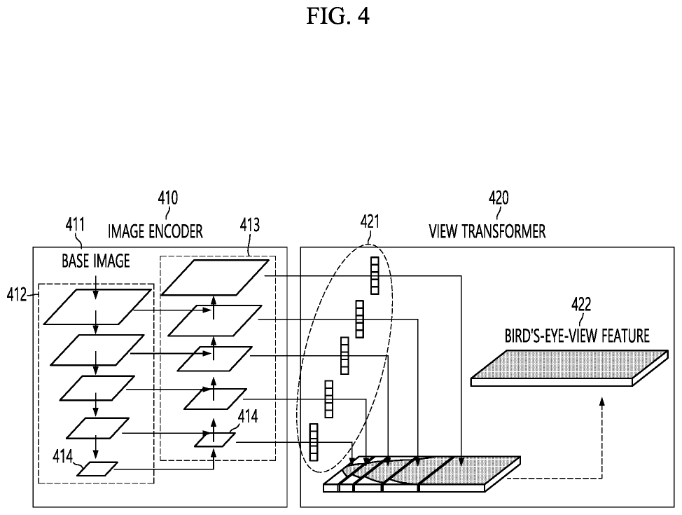

FIG. 4 is an exemplary diagram for describing a method of performing image encoding and view transformation, according to an embodiment.

Referring to FIG. 4, a lane polyline generating device may include an image encoder 410 and a view transformer 420.

The image encoder 410 may use a base image 411 as input data. The base image 411 may be an image of a road on which a vehicle is traveling, obtained from at least one sensor mounted on the vehicle. For example, the at least one sensor mounted on the vehicle may be implemented as the sensor unit 41 described above with reference to FIG. 2.

The image encoder 410 may extract a multi-scale image feature 421 by applying the base image 411 to a feature pyramid network.

The feature pyramid network may include a bottom-up process 412 and a top-down process 413. The bottom-up process 412 may be a forwarding process of generating a plurality of first feature maps by decreasing the resolution of the base image 411 by half at a time by using a convolutional neural network (CNN). For example, in the bottom-up process 412, ResNet50 may be used and first feature maps with sizes of ⅛, 1/16, 1/32, and 1/64 of the base image 411 may be generated.

The top-down process 413 may be a process of generating a plurality of second feature maps by up-sampling a final first feature map 414 generated in the bottom-up process 412 by two times. In addition, the top-down process 413 may be a process of extracting the multi-scale image feature 421 by combining the plurality of second feature maps with the plurality of first feature maps.

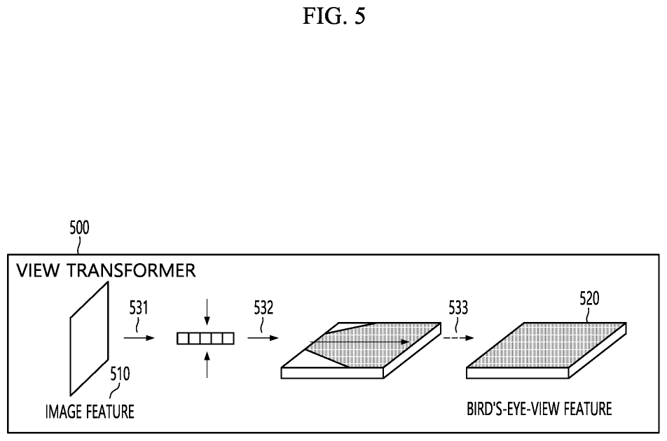

The view transformer 420 may perform view transformation on the multi-scale image feature 421 extracted by the image encoder 410 to generate a bird's-eye-view (BEV) feature 422. A method of generating the BEV feature 422 will be described below with reference to FIG. 5.

FIG. 5 is an exemplary diagram for describing a method of generating a BEV feature, according to an embodiment.

FIG. 5 illustrates a view transformer 500 included in a lane polyline generating device. The view transformer 500 may receive an image feature 510 as an input, and generate a BEV feature 520 by performing certain operations.

In detail, the view transformer 500 may generate the BEV feature 520 by collapsing the image feature 510 in the height dimension in a first operation 531, stretching a multi-scale image feature including the image feature 510 in the depth dimension in a second operation 532, and performing resampling by using camera parameters in a third operation 533.

Meanwhile, the lane polyline generating device may apply homography transformation Hc to the BEV feature 520 fBEVc and remap it to canonical coordinates. In detail, the lane polyline generating device may apply homography transformation to the BEV feature 520 fBEVc according to Equation 1. In Equation 1, I denotes the base image, F(·) denotes an image encoder function, T(·) denotes the view transformer, K denotes parameters related to the camera photographing a certain road (e.g., the focal length and principal point of the camera), R denotes a rotation transformation between a vehicle coordinate system and a camera coordinate system, and t denotes a translation transformation between the vehicle coordinate system and the camera coordinate system. In addition, z=0 means that the transformed BEV feature fBEV, which is a result value according to Equation 1, is a value on the XY plane.

$${f}_{BEV} = {H}_{c} ( {f}_{{BEV}_{c}} , R , t , z = 0 ) , where {f}_{{BEV}_{c}} = 𝒯 ( ℱ ( I ) , K ) \qquad [ Equation 1 ]$$

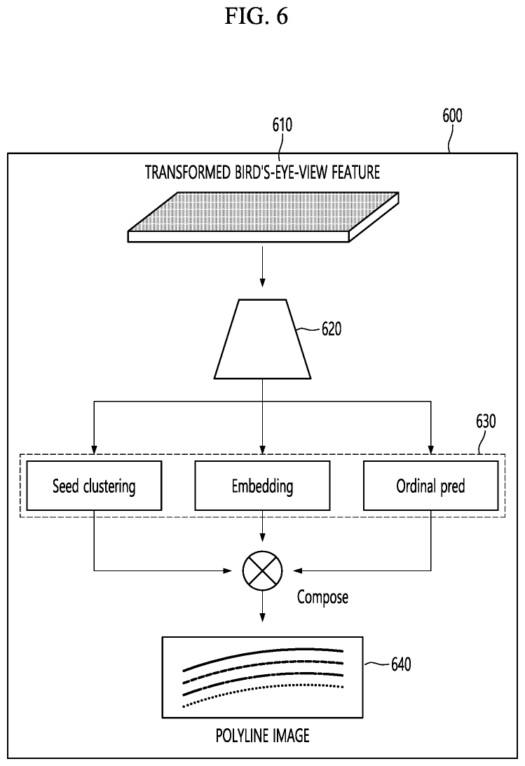

The lane polyline generating device may train a neural network model by using the transformed BEV feature fBEV as input data of the neural network model, and using a lane polyline for a certain road as output data. A method of training the neural network model will be described below with reference to FIG. 6.

FIG. 6 is an exemplary diagram for describing a method of operating a neural network model, according to an embodiment.

FIG. 6 illustrates a neural network model 600. The lane polyline generating device may train the neural network model 600 by using a transformed BEV feature 610 as input data of the neural network model 600, and using a lane polyline 640 for a certain road as output data.

The transformed BEV feature 610 may be input into the neural network model 600 as input data. The transformed BEV feature 610 may be a result value calculated through Equation 1 above. By applying at least one preset layer 620 and a loss function 630 to the transformed BEV feature 610, the lane polyline 640 may be output as output data of the neural network model 600.

In an embodiment, the neural network model 600 may be trained to minimize a value of a loss function L(·) according to Equation 2 below. In Equation 2, I denotes a base image, M(·) denotes the neural network model 600, K denotes parameters related to a camera photographing a certain road (e.g., the focal length and principal point of the camera), R denotes a camera coordinate system, and t denotes a vehicle coordinate system. X_{BEV} denotes a ground truth value of a lane polyline for the certain road. \hat{X}_{BEV} denotes a value predicted by the neural network model 600 for the lane polyline for the certain road.

$$minimize ℒ ( {x}_{BEV} , {\hat{x}}_{BEV} ) , where {\hat{x}}_{BEV} = M ( I ; K , R , t ) \qquad [ Equation 2 ]$$

In the present disclosure, a lane polyline for a certain road may be obtained through end-to-end learning of the neural network model 600 without using a homography function. To this end, in the present disclosure, at least one loss function used for training the neural network model 600 may be set. The loss function will be described below in detail.

Meanwhile, in an embodiment, the neural network model 600 described above with reference to FIG. 6 may also perform the image encoding and view transformation described above with reference to FIGS. 4 and 5.

The lane polyline generating device may train the neural network model 600 by using a base image as input data for the neural network model 600, and using a lane polyline for a certain road as output data.

In detail, the lane polyline generating device may input the base image as input data for the neural network model 600. In addition, the lane polyline generating device may operate the neural network model 600 to generate a BEV feature from the base image, and obtain a lane polyline as output data based on the generated BEV feature. In more detail, the lane polyline generating device may operate the neural network model 600 to extract a multi-scale image feature by using the base image, and perform view transformation on the extracted multi-scale image feature to generate a BEV feature. In addition, the lane polyline generating device may obtain a lane polyline for a certain road as output data based on the generated BEV feature.

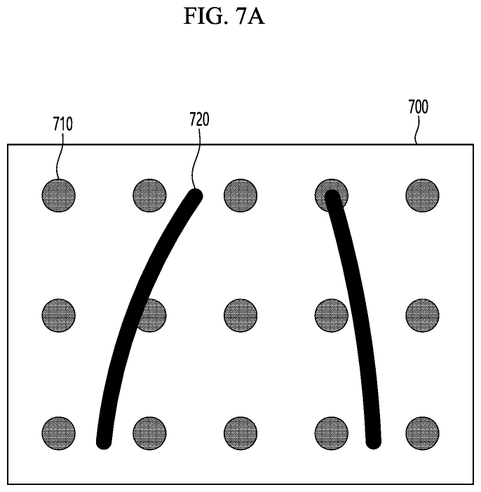

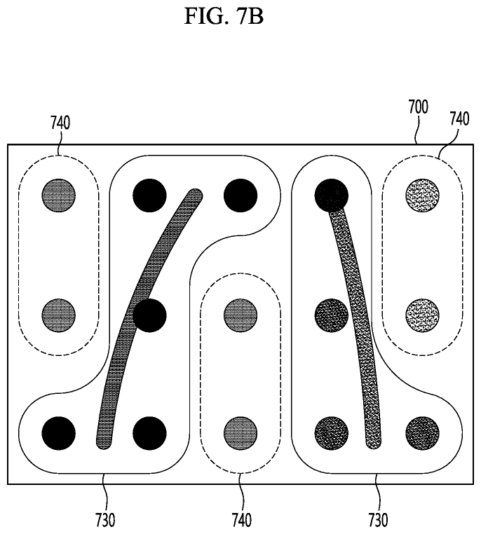

FIGS. 7A and 7B are exemplary diagrams for describing a seed probability loss according to an embodiment.

FIGS. 7A and 7B illustrate a pixel coordinate system 700. The lane polyline generating device may generate the pixel coordinate system 700 by transforming a spatial coordinate system of a BEV feature into an embedding coordinate system.

Referring to FIG. 7A, dots 710 included in the pixel coordinate system 700 represent pixels, and straight lines 720 represent lanes.

The lane polyline generating device may set a seed probability loss as at least one loss function (or loss) applied to a neural network model. A seed probability varies depending on whether each of a plurality of pixels on the pixel coordinate system 700 falls into a category of foreground or background. Here, the foreground refers to objects such as vehicles and lanes, and the background refers to a backdrop. When a certain pixel on the pixel coordinate system 700 is determined as a background, the lane polyline generating device may determine the seed probability of the pixel as 0. In addition, as the probability that a certain pixel on the pixel coordinate system 700 corresponds to the foreground increases, the lane polyline generating device may determine the seed probability of the pixel as a value closer to 1.

The plurality of pixels on the pixel coordinate system 700 are classified into foreground pixels representing the foreground or background pixels representing the background, and referring to FIG. 7B, a first pixel group 730 of a plurality of pixels on the pixel coordinate system 700 corresponds to foreground pixels, and a second pixel group 740 corresponds to background pixels.

In an embodiment, the lane polyline generating device may set a seed probability loss including a first formula and a second formula by applying the first formula to the foreground pixels corresponding to the foreground among the plurality of pixels, and applying the second formula to the background pixels corresponding to the background.

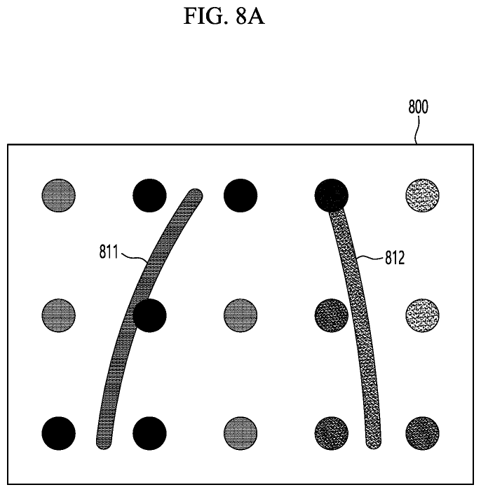

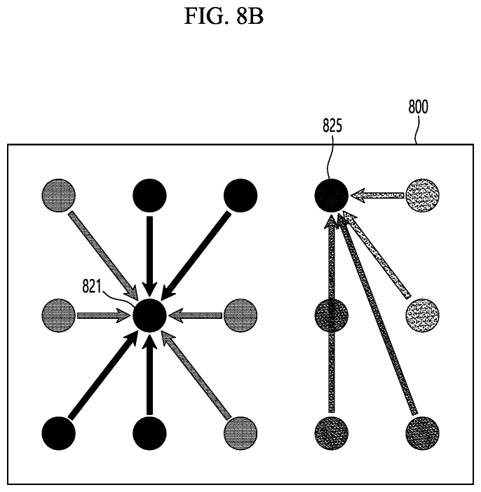

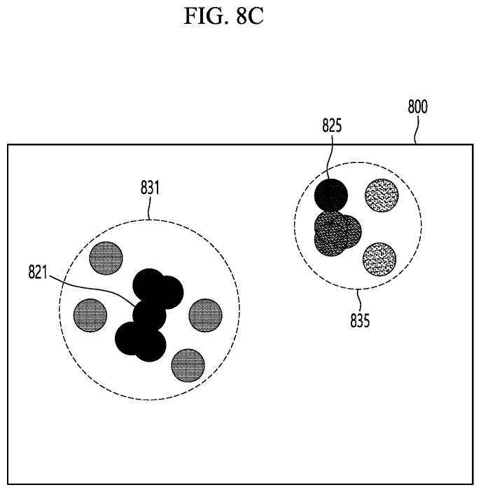

The lane polyline generating device may calculate a probability that each of foreground pixels corresponds to a certain cluster among a plurality of clusters respectively corresponding to a plurality of lanes included in a certain road. The lane polyline generating device may set the first formula based on pixel values of the foreground pixels and the calculated probabilities. Meanwhile, a method of calculating the probability of corresponding to a cluster will be described below with reference to FIGS. 8A to 8C.

In addition, the lane polyline generating device may set the first formula by further applying a scaling factor to correct the imbalance between the pixel values of the foreground pixels and the pixel values of the background pixels.

In addition, the lane polyline generating device may set the second formula based on the pixel values of the background pixels.

The seed probability loss including the first formula and the second formula described above may be expressed as Equation 3 below. In an embodiment, the neural network model may be trained to minimize a value of a seed probability loss L_{seed}(·) according to Equation 3 below.

In Equation 3, the first term on the right side may be the first formula described above, and the second term may be the second formula described above. In addition, in Equation 3, N denotes the number of pixels included in the pixel coordinate system 700, δ denotes a scaling factor, qi denotes a seed prediction value of an i-th pixel, Sk denotes the foreground, bg denotes the background, and ϕₖ(eᵢ) denotes the probability that i-th embedding coordinates ei in the pixel coordinate system 700 correspond to a k-th cluster.

$${ℒ}_{seed} = \frac{1}{N} {\sum }_{i}^{N} δ * {𝕝}_{\{ {q}_{i} ∈ {S}_{k} \}} {‖ {q}_{i} - {ϕ}_{k} ( {e}_{i} ) ‖}^{2} + {𝕝}_{\{ {q}_{i} ∈ bg \}} {‖ {q}_{i} - 0 ‖}^{2} \qquad [ Equation 3 ]$$

FIGS. 8A to 8C are exemplary diagrams for describing an embedding offset loss.

FIGS. 8A to 8C illustrate a pixel coordinate system 800. Referring to FIG. 8A, a first straight line 811 and a second straight line 812 included in the pixel coordinate system 800 represent different lanes.

The lane polyline generating device may set an embedding offset loss as at least one loss function (or loss) applied to a neural network model. An embedding offset represents the probability that i-th embedding coordinates ei in the pixel coordinate system 800 correspond to a k-th cluster. Here, a cluster may be set for each of a plurality of lanes included in a certain road. As the distance between an i-th pixel on the pixel coordinate system 800 and the center of the k-th cluster decreases, the lane polyline generating device may determine a probability value ϕₖ(eᵢ) corresponding to the i-th pixel as a value closer to 1.

Referring to FIG. 8B, the shading of each pixel is a visualization for indicating the probability that the pixel corresponds to a certain cluster, and as the darkness of the shading increases, the probability that the pixel corresponds to the certain cluster increases. A first pixel 821 close to the first straight line 811 and a second pixel 825 close to the second straight line 812 in FIG. 8A are highly likely to correspond to the certain cluster, and thus are indicated in dark shadings in FIG. 8B. Meanwhile, the lane polyline generating device may calculate the probability of corresponding to the certain cluster only for foreground pixels, and omit the calculation for the background pixels.

FIG. 8C illustrates that pixels are grouped into clusters. The above-described BEV feature has spatial coordinates, and the lane polyline generating device may operate the neural network model to transform the BEV feature having the spatial coordinates into two-dimensional embedding coordinates.

The lane polyline generating device may set the first pixel 821 on the embedding coordinates as the centroid for a first cluster 831, and set the second pixel 825 as the centroid for a second cluster 835.

In an embodiment, the lane polyline generating device may extract foreground pixels corresponding to the foreground from a plurality of pixels included in the BEV feature. In addition, the lane polyline generating device may calculate a probability that each of the foreground pixels corresponds to a certain cluster among a plurality of clusters respectively corresponding to a plurality of lanes included in a certain road. In addition, the lane polyline generating device may set an embedding offset loss by using the calculated probabilities. In addition, the lane polyline generating device may train a neural network model by using the embedding offset loss.

In addition, the lane polyline generating device may set a centroid for each of a plurality of clusters on the embedding coordinates, and a fixed margin for generating a cluster. The lane polyline generating device may calculate a probability that each of the foreground pixels corresponds to a certain cluster among the plurality of clusters, by using the centroids and the fixed margin.

In addition, in order to calculate a probability that each of the foreground pixels corresponds to a certain cluster among the plurality of clusters on the embedding coordinates, the lane polyline generating device may set a clustering threshold probability value. The lane polyline generating device may calculate a probability that each of the foreground pixels corresponds to a certain cluster among the plurality of clusters by using the centroids, the fixed margin, and the clustering threshold probability value.

The neural network model may be trained to minimize a value of an embedding offset loss L_{embed}(·) according to Equation 4 below. In Equation 4, K denotes the number of clusters, and Lₕ(·) denotes a support vector machine-related loss (e.g., a Lovasz hinge loss).

$${ℒ}_{embed} = \frac{1}{K} {\sum }_{k = 1}^{K} {ℒ}_{h} ( \{ p \} , \{ {ϕ}_{k} ( {e}_{i} ) \} ) s . t . p = \{ \begin{matrix}1 , & if {e}_{i} ∈ {S}_{k} \\ 0 , & otherwise\end{matrix} {∀}_{{e}_{i}} ∈ fg \qquad [ Equation 4 ]$$

In addition, ϕₖ(eᵢ), that is the probability that each of the foreground pixels corresponds to a certain cluster among the plurality of clusters on the embedding coordinates, may be calculated according to Equation 5 below. According to Equation 5, ϕₖ(eᵢ) follows a Gaussian distribution.

$${ϕ}_{k} ( {e}_{i} ) = exp ( - \frac{{‖ {e}_{i} - \frac{1}{\vert {S}_{k} \vert} {\sum }_{{e}_{j} ∈ {S}_{k}} {e}_{j} ‖}^{2}}{2 {σ}^{2}} ) \qquad [ Equation 5 ]$$

In addition, in Equation 5, @ may be calculated according to Equation 6 below. In Equation 6, R denotes a fixed margin for generating a cluster in an embedding space, and Pr-denotes a clustering threshold probability value.

$$σ = R \sqrt{- 0.5 log {P}_{r}} \qquad [ Equation 6 ]$$

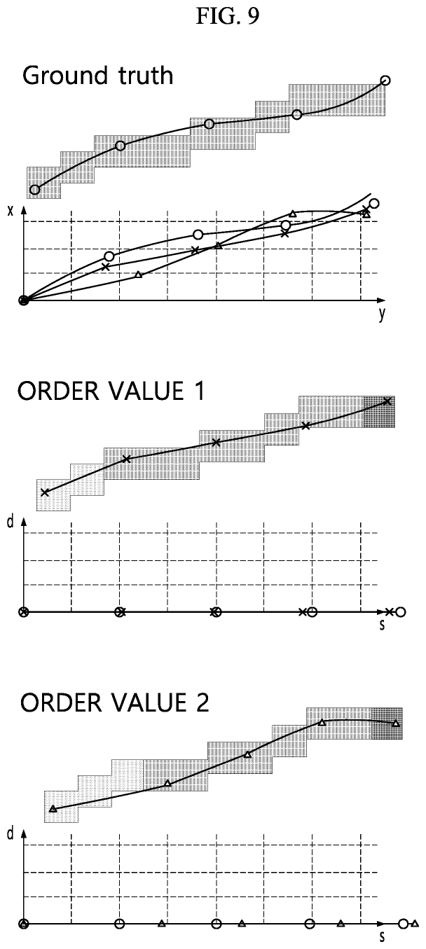

FIG. 9 is an exemplary diagram for describing an order loss according to an embodiment.

The lane polyline generating device may set an order loss as at least one loss function (or loss) applied to a neural network model. Here, the order refers to an order for the start and end of a lane corresponding to a polyline. The lane polyline generating device may determine an order value of a certain pixel on a pixel coordinate system, as a value closer to 0 as the distance between the pixel and the starting point of the lane decreases, and determine the order value as a value closer to 1 as the distance between the pixel and the ending point of the lane decreases.

FIG. 9 illustrates an order in which each pixel on the pixel coordinate system is arranged between the starting point and the ending point of the lane. Order value 1 and order value 2 in FIG. 9 represent result values for different lanes (or clusters). In FIG. 9, as the darkness of a shading increases, the distance between a certain pixel and the ending point of the lane decreases.

In an embodiment, the lane polyline generating device may extract foreground pixels corresponding to the foreground from a plurality of pixels included in a BEV feature. In addition, the lane polyline generating device may set an order loss using an order of each of foreground pixels for a lane included in a certain road, and train the neural network model by using the order loss.

In addition, in order to set the order loss, the lane polyline generating device may identify a cluster including each of the foreground pixels and determine order values of the foreground pixels for the lane corresponding to the identified cluster. The lane polyline generating device may set the order loss by using the order value for each of the foreground pixels.

In addition, in order to determine the order values, the lane polyline generating device may determine the order values of the foreground pixels such that, as the distance between the starting point of the lane and the foreground pixel decreases, the order value is closer to a first value, and as the distance between the ending point of the lane and the foreground pixel decreases, the order value is closer to a second value.

The lane polyline generating device may set the order loss by using a smooth L1 algorithm, but the algorithm used is not limited thereto.

The neural network model may be trained to minimize a value of an order loss L_{ord}(·) according to Equation 7 below. In Equation 7, dn denotes an order value of a n-th pixel and has a value between 0 and 1. d\hat{ }n denotes a ground truth value.

$${ℒ}_{ord} = \frac{1}{\vert fg \vert} {\sum }_{{d}_{n} , {\hat{d}}_{n} ∈ fg} Smooth L 1 ( {d}_{n} , {\hat{d}}_{n} ) \qquad [ Equation 7 ]$$

Meanwhile, the smooth L1 algorithm may be expressed as Equation 8.

$$Smooth L 1 = \{ \begin{matrix}0.5 {( {d}_{n} - {\hat{d}}_{n} )}^{2} / λ , & if \vert {d}_{n} - {\hat{d}}_{n} \vert < λ \\ \vert {d}_{n} - {\hat{d}}_{n} \vert - 0.5 * λ , & otherwise\end{matrix} . \qquad [ Equation 8 ]$$

The lane polyline generating device may train the neural network model to minimize at least one of the embedding offset loss, the seed probability loss, and the order loss.

In an embodiment, the lane polyline generating device may train the neural network model to minimize a final loss according to Equation 9 below. In Equation 9, α,β,γ may be set differently depending on the importance of each term.

$${ℒ}_{total} = α {ℒ}_{embed} + β {ℒ}_{seed} + γ {ℒ}_{ord} \qquad [ Equation 9 ]$$

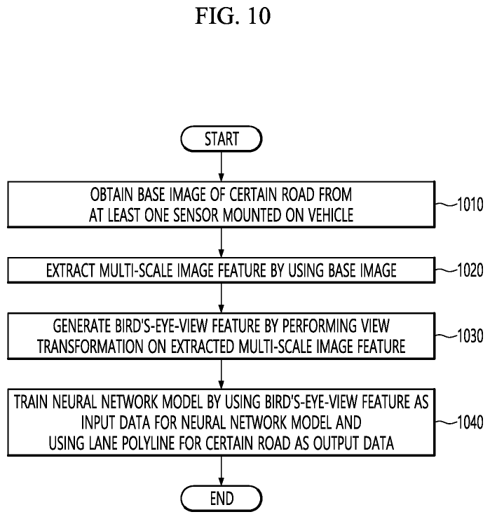

FIG. 10 is a flowchart for describing a method of generating a lane polyline by using a neural network model, according to an embodiment.

Referring to FIG. 10, in operation 1010, the lane polyline generating device may obtain a base image of a certain road from at least one sensor mounted on the vehicle.

In operation 1020, the lane polyline generating device may extract a multi-scale image feature by using the base image.

In operation 1030, the lane polyline generating device may generate a BEV feature by performing view transformation on the extracted multi-scale image feature.

In operation 1040, the lane polyline generating device may train the neural network model by using the BEV feature as input data for the neural network model and using a lane polyline for the certain road as output data.

In an embodiment, the lane polyline generating device may extract foreground pixels corresponding to the foreground from a plurality of pixels included in the BEV feature, calculate a probability that each of the foreground pixels corresponds to a certain cluster among a plurality of clusters respectively corresponding to a plurality of lanes included in the certain road, set an embedding offset loss using the calculated probabilities, and train the neural network model by using the embedding offset loss.

In addition, in order to calculate the probabilities, the lane polyline generating device may set a centroid for each of the plurality of clusters, and a fixed margin for generating a cluster. The lane polyline generating device may calculate a probability that each of the foreground pixels corresponds to a certain cluster among the plurality of clusters, by using the centroids and the fixed margin.

In addition, in order to calculate the probabilities, the lane polyline generating device may set a clustering threshold probability value. The lane polyline generating device may calculate a probability that each of the foreground pixels corresponds to a certain cluster among the plurality of clusters by using the centroids, the fixed margin, and the clustering threshold probability value.

In an embodiment, the lane polyline generating device may set a seed probability loss based on whether each of the plurality of pixels included in the BEV feature corresponds to a category of foreground or background, and train the neural network model by using the seed probability loss.

In addition, in order to set the seed probability loss, the lane polyline generating device may set the seed probability loss including a first formula and a second formula by applying the first formula to foreground pixels corresponding to the foreground among the plurality of pixels, and applying the second formula to background pixels corresponding to the background.

In addition, the lane polyline generating device may calculate a probability that each of the foreground pixels corresponds to a certain cluster among a plurality of clusters respectively corresponding to a plurality of lanes included in a certain road. The lane polyline generating device may set the first formula based on pixel values of the foreground pixels and the calculated probabilities.

In addition, the lane polyline generating device may set the second formula based on the pixel values of the background pixels.

In addition, the lane polyline generating device may set the first formula by further applying a scaling factor to correct the imbalance between the pixel values of the foreground pixels and the pixel values of the background pixels.

In an embodiment, the lane polyline generating device may extract the foreground pixels corresponding to the foreground from the plurality of pixels included in the BEV feature, set an order loss using an order of each foreground pixel for a lane included in the certain road, and train the neural network model by using the order loss.

In addition, the lane polyline generating device may identify a cluster including each of the foreground pixels and determine order values of the foreground pixels for the lane corresponding to the identified cluster. The lane polyline generating device may set the order loss using the order value for each of the foreground pixels.

In addition, the lane polyline generating device may determine the order values of the foreground pixels such that, as the distance between the starting point of the lane and the foreground pixel decreases, the order value is closer to a first value, and as the distance between the ending point of the lane and the foreground pixel decreases, the order value is closer to a second value.

In an embodiment, the lane polyline generating device may train the neural network model to minimize at least one of the embedding offset loss, the seed probability loss, and the order loss.

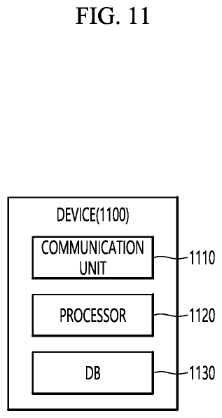

FIG. 11 is a block diagram of a lane polyline generating device according to an embodiment.

Referring to FIG. 11, a lane polyline generating device 1100 may include a communication unit 1110, a processor 1120, and a database (DB) 1130. FIG. 11 illustrates the lane polyline generating device 1100 including only the components related to an embodiment. Therefore, it would be understood by those of skill in the art that other general-purpose components may be further included in addition to those illustrated in FIG. 11.

The communication unit 1110 may include one or more components for performing wired/wireless communication with an external server or an external device. For example, the communication unit 1110 may include at least one of a short-range communication unit (not shown), a mobile communication unit (not shown), and a broadcast receiver (not shown).

The DB 1130 is hardware for storing various pieces of data processed by the lane polyline generating device 1100, and may store a program for the processor 1120 to perform processing and control.

The DB 1130 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1120 controls the overall operation of the lane polyline generating device 1100. For example, the processor 1120 may execute programs stored in the DB 1130 to control the overall operation of an input unit (not shown), a display (not shown), the communication unit 1110, the DB 1130, and the like. The processor 1120 may execute programs stored in the DB 1130 to control the operation of the lane polyline generating device 1100.

The processor 1120 may control at least some of the operations of the lane polyline generating device 1100 described above with reference to FIGS. 1 to 10. The lane polyline generating device 1100 and the autonomous driving device 40 may be the same device, or at least some of the operations performed by the devices may be the same.

The processor 1120 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the lane polyline generating device 1100 may be a mobile electronic device. For example, the lane polyline generating device 1100 may be implemented as a smart phone, a tablet personal computer (PC), a PC, a smart television (TV), a personal digital assistant (PDA), a laptop computer, a media player, a navigation system, a camera-equipped device, and other mobile electronic devices. In addition, the lane polyline generating device 1100 may be implemented as a wearable device having a communication function and a data processing function, such as a watch, glasses, a hair band, a ring, or the like.

In another embodiment, the lane polyline generating device 1100 may be an electronic device embedded in a vehicle. For example, the lane polyline generating device 1100 may be an electronic device that is manufactured and then inserted into a vehicle through tuning.

In another embodiment, the lane polyline generating device 1100 may be a server located outside a vehicle. The server may be implemented as a computer device or a plurality of computer devices that provide a command, code, a file, content, a service, and the like by performing communication through a network. The server may receive data necessary for generating a lane polyline from devices mounted on the vehicle, and determine the movement path of the vehicle based on the received data.

In another embodiment, a process performed by the lane polyline generating device 1100 may be performed by at least some of a mobile electronic device, an electronic device embedded in the vehicle, and a server located outside the vehicle.

An embodiment of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to one of ordinary skill in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as failing within the scope of the present disclosure.

1. A method of generating a lane polyline by using a neural network model, the method comprising:
obtaining a base image of a certain road from at least one sensor mounted on a vehicle;
extracting a multi-scale image feature by using the base image;
generating a bird's-eye-view (BEV) feature by performing view transformation on the extracted multi-scale image feature; and
training a neural network model by using the BEV feature as input data for the neural network model and using a lane polyline for the certain road as output data.

2. The method of claim 1, wherein the training of the neural network model comprises:
extracting foreground pixels corresponding to a foreground from a plurality of pixels included in the BEV feature;
calculating a probability that each of the foreground pixels corresponds to a certain cluster among a plurality of clusters respectively corresponding to a plurality of lanes included in the certain road;
setting an embedding offset loss that uses the calculated probability; and
training the neural network model by using the embedding offset loss.

3. The method of claim 2, wherein the calculating of the probability comprises:
setting a centroid for each of the plurality of clusters, and a fixed margin for generating a cluster; and
calculating the probability that each of the foreground pixels corresponds to the certain cluster among the plurality of clusters by using the centroid and the fixed margin.

4. The method of claim 3, wherein the calculating of the probability further comprises:
setting a clustering threshold probability value; and
calculating the probability that each of the foreground pixels corresponds to the certain cluster among the plurality of clusters, by using the centroid, the fixed margin, and the clustering threshold probability value.

5. The method of claim 1, further comprising:
inputting the BEV feature as input data for the neural network model that has been trained by the method of claim 1; and
generating a lane polyline for the certain road as output data of the neural network model.

6. The method of claim 5, further comprising, based on the lane polyline for the certain road, generating a control signal for controlling the vehicle traveling on the certain road.

7. A device for generating a lane polyline by using a neural network model, the device comprising:
a memory storing at least one program; and
a processor configured to execute the at least one program to operate the neural network,
wherein the processor is further configured to
obtain a base image of a certain road from a camera mounted on a vehicle,
extract a plurality of image features by using the base image,
generate a bird's-eye-view feature by performing view transformation on the extracted plurality of image features, and
train the neural network model by using the bird's-eye-view feature as input data for the neural network model and using a lane polyline for the certain road as output data.

8. A computer-readable recording medium having recorded thereon a program for causing a computer to execute the method of claim 1.

9. A method of generating a lane polyline by using a neural network model, the method comprising:
obtaining a base image of a certain road from at least one sensor mounted on a vehicle;
inputting the base image as input data for a neural network model; and
operating the neural network model to generate a bird's-eye-view feature from the base image and obtain a lane polyline as output data based on the generated bird's-eye-view feature.
